(19) United States
(12) Patent Application Publication
(10) Pub. No.: US 2020/0146477 A1
(43) Pub. Date: May 14, 2020

(54) PLATEWARE WITH ACTIVE TEMPERATURE CONTROL

(71) Applicant: Ember Technologies, Inc., Westlake Village, CA (US)

(72) Inventors: Clayton Alexander, Westlake Village, CA (US); Daren John Leith, Agoura Hills, CA (US); Christopher Thomas Wakeham, Solana Beach, CA (US); Mikko Juhani Timperi, San Marcos, CA (US)

(21) Appl. No.: 16/626,157

(22) PCT Filed: Jul. 6, 2017
(86) PCT No.: PCT/US2018/041007

§ 371 Date: Dec. 23, 2019

(51) Int. Cl. A47G 19/02; A47J 36/24

(52) U.S. Cl. CPC A47G 19/027; A47J 36/2483

(57) ABSTRACT

A plateware device with an active temperature control system can have a double-walled body with a top metal panel and a bottom metal panel spaced from the top metal panel to define a cavity therebetween. A base (of metal or plastic) can be attached to the bottom metal panel to close the cavity. An outer surface of the doubled-walled body can have a ceramic coating so the plateware device resembles a conventional plateware device. The temperature control system can be disposed in the cavity and can include one or more heat transfer elements in thermal communication with a bottom surface of the top panel to heat at least a portion of the top panel, and control circuitry configured to control operation of the one or more heat transfer elements. The control circuitry is optionally further configured to wirelessly communicate with a mobile electronic device, the control circuitry configured to control the operation of the one or more heat transfer elements based at least in part on information it receives from the mobile electronic device.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application is related to U.S. patent application Ser. No. 15/593,085, filed May 11, 2017.

### BACKGROUND

### Field

The present invention is directed to a plateware device, and more particularly to a plateware device with active temperature control to heat or cool contents thereof.

### Description of the Related Art

Ceramic plateware, such as dinner plates, platters, serving plates, soup tureens, etc., are well known and used at home, in restaurants and cafes. However, conventional ceramic plateware do not allow the food thereon to remain hot during consumption or use, so that the temperature of the food on the plateware decreases during consumption. Ceramic plateware also have poor thermal conductivity, making common ceramic plateware unsuitable for use with a heating unit (e.g., to try to heat the food on the plateware to maintain it in a heated state during the consumption of the food on the plateware).

### SUMMARY

There is a need for plateware with active temperature control that can be used for heating or cooling the contents thereof (e.g., solid food, soup) for an extended period of time (e.g., the entire meal session), that is easy to use and that can optionally communicate with electronics (e.g., smartphones) to allow easy operation. Additionally, there is a need for plateware with active temperature control that is sturdy and durable so that it does not break (e.g., when dropped). Further, there is a need for plateware with active temperature control that resembles conventional plateware, and can be washed without risking damage to the electronics in the module.

In accordance with one aspect, a plateware device with an active temperature control system is provided. The plateware device optionally has a double-walled body with a top metal panel and a bottom metal panel spaced from the top metal panel to define a cavity therebetween. An outer surface of the doubled-walled body optionally has a ceramic coating so the plateware device resembles a conventional plateware device. The temperature control system can optionally be disposed in the cavity and can include one or more heat transfer elements in thermal communication with a bottom surface of the top panel to heat at least a portion of the top panel, and control circuitry configured to control operation of the one or more heat transfer elements. The control circuitry is optionally further configured to wirelessly communicate with a mobile electronic device, the control circuitry configured to control the operation of the one or more heat transfer elements based at least in part on information it receives from the mobile electronic device.

The plateware device can optionally be a dinner plate, a platter, a serving dish, a soup tureen, a bowl or other plateware device.

### BRIEF DESCRIPTION OF THE DRAWINGS

FIGS. 1A-1B are a schematic cross-sectional exploded and assembled view of one embodiment of plateware.

FIG. 2 is a schematic block diagram showing communication between the plateware with active temperature control and a remote electronic device.

FIG. 3 is a schematic illustrating wireless communication between the plateware device and a remote electronic device.

### DETAILED DESCRIPTION

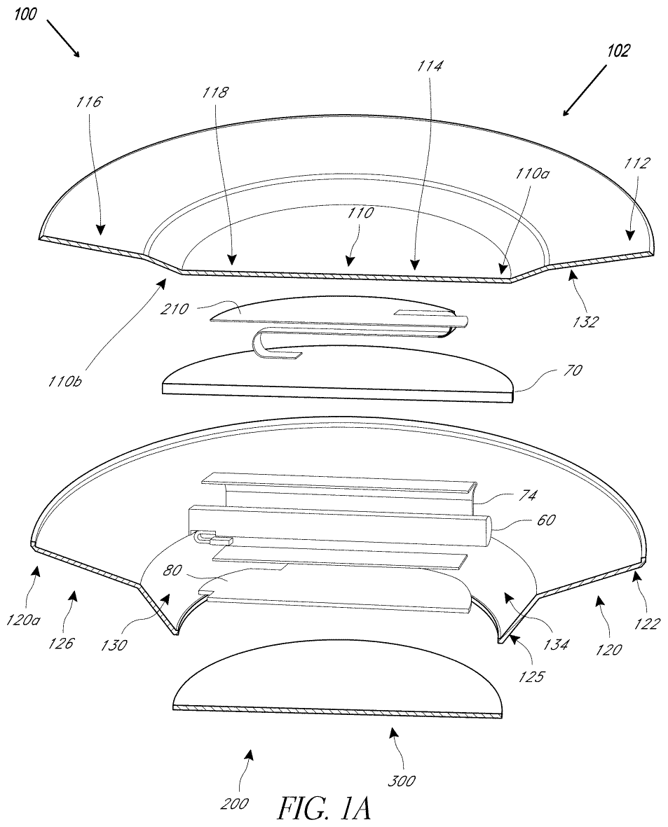

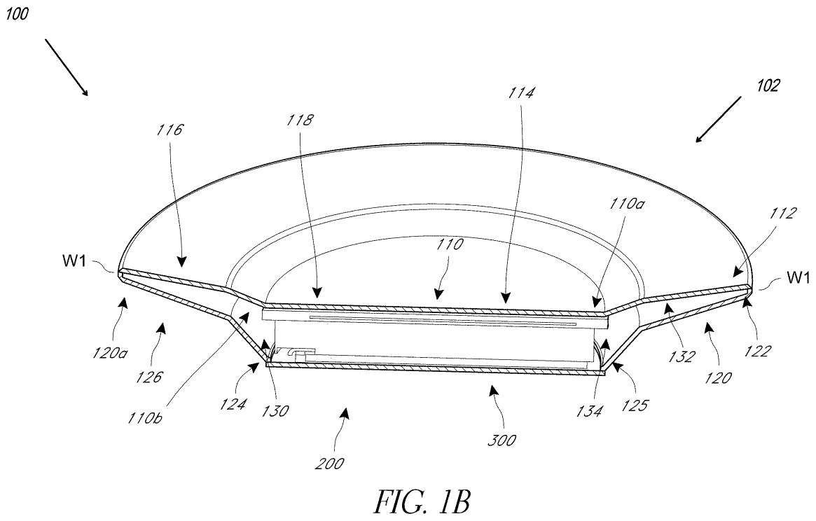

FIGS. 1A-1B shows a plateware device 100, for example a plate, with active temperature control. Alternatively, the plateware can be a platter, serving plate, bowl, soup tureen or other device for holding foodstuff thereon (e.g., during a meal). The plateware device 100 is made of metal, which advantageously provides increased durability and inhibits breaking thereof (e.g., when dropped). Optionally, the plateware device 100 can be made of stainless steel.

The plateware device 100 can have a body 102 defined at least in part by a top panel 110 that extends to an outer edge 112, and a bottom panel 120 that extends to an outer edge 122. The top panel 110 can optionally have a central portion 114 and a peripheral or annular portion 116 that extends upwardly from the central portion 114 to the outer edge 112 to define a recessed portion 118 that can substantially retain foodstuff thereon without allowing the foodstuff to roll off the top panel 110. Optionally, the central portion 114 can be planar. Alternatively, the central portion 114 can be curved. The bottom panel 120 can have a central portion 124 and a peripheral or annular portion 126 that extends from the central portion 124 to the outer edge 122. The central portion 124 can be disposed below the central portion 114. The central portion 124 can have an opening 125 disposed under the central portion 114 (e.g., so that the central portion 114 and opening 125 are defined about a central axis of the plateware device 100). The top panel 110 can be attached to the bottom panel 120. Optionally, the top panel 110 can be welded W1 to the bottom panel 120 along the outer edges 112, 122. Optionally, when the top and bottom panels 110, 120 are attached, the peripheral or annular portion 126 of the bottom panel 120 can align with the peripheral or annular portion 116 of the top panel 110, and the central portion 124 of the bottom panel 120 can align with the central portion 114.

The top panel 110 can have an outer surface 110a and the bottom panel 120 can have an outer surface 120a. Optionally, the outer surfaces 110a, 120a can be coated with a ceramic material so that the plateware device 100 looks like a conventional plateware device (e.g., looks like a conventional ceramic plate, platter, serving dish, bowl, etc.).

Optionally, the top panel 110 can be spaced apart from the bottom panel 120 to define a cavity 130 therebetween. The peripheral or annular portion 126 can optionally be spaced from the peripheral or annular portion 116 to define an annular cavity 132 therebetween, and the central portion 114 of the top panel 110 can optionally be spaced from the central portion 124 of the bottom panel 120 to define a central cavity 134 therebetween. Accordingly, the plateware device 100 can optionally be double walled. Optionally, the top panel 110 can have a thickness of between about 0.2 mm and about 13 mm, such as about 0.3 mm. The plateware device 100 can be made of a thermally conductive material, such as a metal (e.g., stainless steel). One or both of the top panel 110 and bottom panel 120 can optionally be stamped or hydroformed stainless steel with a ceramic coating on their outer surfaces 110a, 120a.

The cavity 130 can optionally be at least partially filled with an insulative material. Optionally, the annular cavity 132 can be at least partially filled with an insulative material to advantageously enhance the thermal properties of the plateware device 100 by inhibiting heat loss through the peripheral portions 116, 126. Optionally, the central cavity 134 is not filled with an insulative material. Additionally, the insulative material can reduce or inhibit the metallic sound of the plateware device 100 (e.g., ceramic coated plate), allowing the plateware device 100 to sound similar to a conventional ceramic plateware device (e.g., similar to a conventional ceramic plate, platter, serving plate, etc.).

A temperature control system 200 can optionally be at least partially disposed in the cavity 130 between the top panel 110 and the bottom panel 120. The temperature control system 200 can advantageously operate to increase or maintain a temperature of a foodstuff on the plateware device 100 (e.g., foodstuff in the recessed portion 118 of the plateware device 100). The term “active”, as used herein, is not limited to continuous operation of the system 200. As used herein, heat transfer encompasses a heating, as well as a cooling, process. Therefore, a “heat transfer element” as used herein is an element that can effect a heating and/or a cooling process.

With continued reference to FIGS. 1A-1B, the temperature control system 200 (e.g., a heating system, a cooling system, a heating/cooling system) can optionally include one or more of heat transfer elements 210 (e.g., heating elements or cooling elements or heating/cooling elements, such as thermoelectric or Peltier elements), optionally include one or more power storage element 60, and optionally include control circuitry 80.

The one or more heat transfer elements 210 can be in thermal communication with the central portion 114 of the top panel 110. Optionally, the one or more heat transfer elements 210 can contact a bottom surface 110b of the top panel 110 (e.g., a bottom surface of the central portion 114). Optionally, the one or more heat transfer elements 210 can be a resistive heater. Alternatively, the one or more heat transfer elements 210 can be adhered to the bottom surface 110b of the top panel 110 with an adhesive. The one or more heat transfer elements 210 can be part of a heater flex attached (e.g., adhered) to the bottom surface 110b of the top panel 110. The one or more heat transfer elements 210 can connect with the control circuitry 80 (e.g., a printed circuit board, PCB).

The control circuitry 80 can control the operation of the one or more heat transfer elements 210 to control the amount of energy supplied to the foodstuff on the plateware device 100 to maintain or increase or decrease the temperature of the foodstuff. Optionally, the control circuitry 80 can control delivery of power to the one or more heat transfer elements 210 based at least in part on information from one or more sensors S1-Sn that sense a parameter of quality of the foodstuff (e.g., temperature, volume, level in the recessed portion 118) where said one or more sensors S1-Sn can be on a surface of the container 100. For example, such sensors can be on the bottom surface 110b of the top panel 110 and/or the top surface 110a of the top panel 110.

The control circuitry 80 can include a memory that stores or receives one or more algorithms (e.g., wirelessly via a tablet or smartphone app, via a wired connection or during manufacturing of the plateware device 100 at the factory) that can be executed by the control circuitry 80 to control the operation of the one or more heat transfer elements 210 and/or to determine a parameter of the foodstuff based on sensed information. Such algorithms can optionally be used to determine one or more parameters of the foodstuff in the container 100 based on sensed information for another parameter of the foodstuff. The container 100 can optionally include one or more sensors in communication with the recessed portion 118 (e.g., whose sensed information can provide an indication of a temperature of the foodstuff in the plateware device 100, and an algorithm can calculate a volume of the foodstuff in the recessed portion 118 based on the sensed information of the same sensor. For example, by sensing how long it takes for the foodstuff to change temperature upon actuation of the one or more heat transfer elements 210, the algorithm can calculate the approximate volume of foodstuff on the plateware device 100.

The sensed temperature (by at least one of the sensors S1-Sn) can be communicated to the control circuitry 80, which can then adjust the amount of power supplied to the one or more heat transfer elements 210 based on the sensed temperature (e.g., the control circuitry can reduce power to the one or more heat transfer elements 210 as the desired temperature for the foodstuff is approached). Additionally, the control circuitry 80 can control the operation of the one or more heat transfer elements 210 based on preselected temperature (e.g., user selected temperature, such as one provided by the user directly via an optional user interface on the plateware device 100, or optionally provided wirelessly via a tablet or smartphone app), or based on a predetermined temperature set point (e.g., temperature set point saved into a memory of the control circuitry 80, either by a user, such as via a tablet or smartphone app, or at the factory during manufacture). The control circuitry 80 can advantageously control the amount of power supplied to the one or more heat transfer elements 210 to prevent the temperature of the foodstuff from increasing above the predetermined or preselected temperature. For example, the control circuitry 80 can optionally include a temperature sensitive switch (e.g., temperature limiting switch0, which can open if the sensed temperature of the foodstuff on the plateware device 100 increases above a temperature set point, thereby cutting off power supply to the one or more heat transfer elements 210.

The plateware device 100 can optionally have a thermally insulative layer 70 between the one or more heating elements 210 and the optional one or more power storage elements 60 and optional control circuitry 80 to inhibit heating of these electronics by the one or more heating elements 210. The temperature control system 200 optionally includes a heat sink panel 74 disposed over the optional power storage elements 60, where the heat sink panel 74 contacts a surface of the plateware device 100 (e.g., a bottom panel 120) to thereby dissipate heat generated in the cavity 130 (e.g., heat generated by the one or more power storage elements 60) to the plateware device 100, thereby improving the performance of the thermal control system 200 and inhibiting heat up of the electronics in the cavity 130.

The plateware device 100 can have an end cap or detachable base 300 that removably couples to the bottom panel 120 to close the opening 125 and seal the temperature control system 200 in the cavity 130. Optionally, the end cap 300 is made of plastic. Alternatively, the end cap 300 can be made of metal. Advantageously, the end cap 300 provides a water seal that inhibits entry of water into the cavity 130. The end cap 300 is removable to allow servicing of the electronics of the temperature control system 200 (e.g., to replace one or more of the optional power storage elements 60). The end cap 300 can have one or more electrical contacts on a bottom surface thereof, where the electrical contacts are electrically connected to the optional control circuitry 80 in the cavity 130.

Optionally, power can be provided to the plateware device 100 via a charging or power base (not shown) on which the plateware device 100 is placed. Optionally, the charging or power base has one or more electrical contacts that contact the electrical contacts on the end cap 300. Alternatively, the charging or power base provides power to the control circuitry 80 via inductive coupling. Where the power storage elements are excluded, the charging or power base can provide power to the control circuitry 80, which can controllably provide said power to the one or more heat transfer elements 210 to heat (or cool) the foodstuff on the plateware device 100. Alternatively, where one or more power storage elements 60 are provided in the plateware device 100, the charging or power base can provide power to the control circuitry 80, which can controllably charge the one or more power storage elements 60 and/or provide power to the one or more heat transfer elements 210.

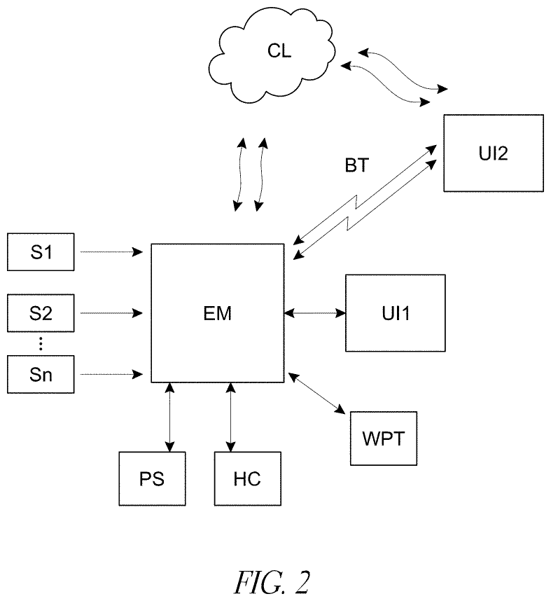

FIG. 2 shows a block diagram of a communication system for the plateware device. The electronic module EM of the plateware device 100, which can include the control circuitry 80, can receive sensed information from one or more sensors S1-Sn (e.g., liquid level sensors, liquid volume sensors, temperature sensors, battery charge sensors, capacitance sensors, tilt sensors or gyroscopes). The electronic module EM can optionally also receive information from and transmit information (e.g., instructions) to one or more heating elements (or cooling elements or heating/cooling elements) HC, such as the heat transfer elements 210 (e.g., to operate each of the heating elements in a heating mode, turn off, turn on, vary power output of, etc.) and optionally to one or more power storage devices PS, such as the power storage elements 60 (e.g., batteries, such as to charge the batteries or manage the power provided by the batteries to the one or more heating or cooling elements). The electronic module EM can optionally also communicate with a wireless power transmitter WPT (e.g., an inductive power transmitter, such as in a charging or power base) optionally in the system 200. The electronic module EM can optionally also communicate with (e.g., transmit information to and receive information, such as user instructions like temperature setpoints from) a user interface UI1 on the plateware device 100 (e.g., on the body 102 of the plateware device 100). The electronic module EM can optionally also communicate with an electronic device ED (e.g., a mobile electronic device such as a mobile phone, PDA, tablet computer, laptop computer, electronic watch; or a desktop computer) via the cloud CL or via a wireless communication system such as Bluetooth BT. The electronic device ED can have a user interface UI2, that can display information associated with the operation of the temperature control system 200 (as disclosed herein), and that can receive information (e.g., instructions, such as user selected temperature for the foodstuff on the plateware device 100) from a user and communicate said information to the temperature control 200 (e.g., to the control circuitry 80).

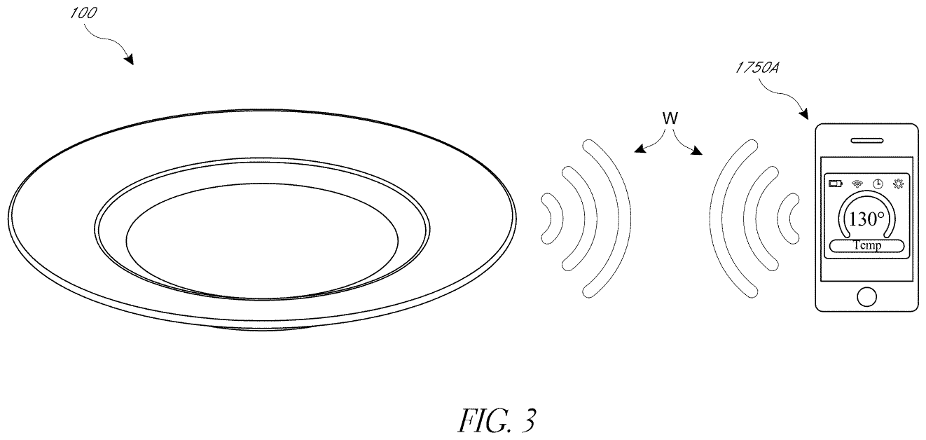

The control circuitry EM can control delivery of power to the one or more heating elements HC to maintain the foodstuff on the plateware device 100 at the predetermined temperature, or can control delivery of power to the one or more heating elements HC to input heat to the foodstuff to increase the temperature of the foodstuff to a user selected temperature. Said user selected temperature can optionally be provided via a user interface on the body of the plateware device 100 (e.g., on the top panel 110, or on the bottom panel 120, or on the end cap 300). Optionally, the user selected temperature can be provided wirelessly W to the control circuitry EM (which can have a receiver, or transceiver) from a portable electronic device (e.g., smart phone or tablet computer) 1750A, e.g., so that there are no buttons or other controls on the plateware device 100 that the user manually actuates (see FIG. 3). The temperature can optionally be preselected or preset (e.g., during manufacture). Optionally, the control circuitry EM can control delivery of power to the one or more heating elements HC based at least in part on information from the one or more sensors S1-Sn that sense a parameter or quality of the foodstuff (e.g., temperature, liquid volume or level, acidity, pH). Said sensors S1-Sn can be any of the sensors disclosed herein and can communicate with the control circuitry EM in any manner disclosed herein.

The term “electronic module” is meant to refer to electronics generally. Furthermore, the term “electronic module” should not be interpreted to require that the electronics be all in one physical location or connected to one single printed circuit board (PCB). One of skill in the art will recognize that the electronic module or electronics disclosed herein can be in one or more (e.g., plurality) of separate parts (coupled to one or a plurality of PCBs) and/or located in different physical locations of the plateware device 100, as disclosed herein. That is, the electronic module or electronics can have different form factors.

### Sensors

With respect to any of the containers disclosed above, one or more sensors S1-Sn can be provided. At least one sensor S2 of the one or more sensors S1-Sn can optionally sense a liquid level (or information indicative of a liquid level) in a chamber 30 of the container 100.

The sensor S2 can optionally be a load cell that can sense a weight of the plateware device 100. The electronic module EM of the plateware device 100 can receive the sensed weight information and compare it against a reference weight data (e.g., previously sensed when the plateware device 100 was empty and/or that is stored in a memory of the electronic module EM), and calculate a volume or level of the foodstuff in the plateware device 100 (e.g., using an algorithm to convert the sensed weight information to foodstuff volume or level measurement).

Alternatively, the sensor S2 can be a pressure sensor on a portion of the plateware device 100 and can sense a hydrostatic pressure of the foodstuff (e.g., in the recessed portion 118). The electronic module EM can calculate a volume or level based at least in part on the sensed pressure information from the sensor S2.

Alternatively, the sensor S2 can be a capacitance sensor (e.g., capacitance sensing strip) that extends along at least a portion of the length of the plateware device 100. The sensor S2 can sense a capacitance of a foodstuff on the plateware device 100 relative to a capacitance of air above the foodstuff and communicate the sensed information to the electronic module EM, which can provide a measurement of volume or level of foodstuff on the plateware device 100 based on the sensed information. The sensor S2 can optionally sense a conductivity of the foodstuff or air proximate the sensor and the electronic module EM can provide a measurement of foodstuff level or volume based at least in part on the sensed information.

Alternatively, the sensor S2 can be an ultrasonic sensor on a sidewall of the plateware device 100. The sensor S2 can use a pulse-echo or wall resonance (e.g. resonance of the sidewall of the plateware device 100) to sense information indicative of a foodstuff level on the plateware device. For example, the sensor S2 can sense a time it takes for pulse emitted by the sensor S2 into the recessed portion 118 of the plateware device 100 to return to the sensor (e.g., once it bounces from the level location). The sensor S2 can transmit the sensed information to the electronic module EM, which can provide a measurement of foodstuff volume or liquid level on the plateware device based on the sensed information.

Alternatively, level in the plateware device 100 is measured based on sensed temperature (or information indicative of temperature) from one or more (e.g., a plurality of) temperature sensors S3. The one or more sensors S3 can optionally sense how long it takes the temperature to increase a reference number of degrees (e.g., 1 degree F. or 1 degree C.) when the plateware device 100 is full of foodstuff to provide a first reference time, and the first reference time can be stored in a memory (e.g., a memory of the electronic module EM). Optionally, additional reference times can be provided by the one or more sensors S3 when the plateware device 100 has other volumes of foodstuff thereon (e.g., half full, ¾ full) and the reference times stored in said memory.

During operation, the one or more temperature sensors S3 can measure how long it takes for the sensed temperature to change by said reference number of degrees and communicate the sensed time information to the electronic module EM, which can provide a measurement of foodstuff volume or level on the plateware device 100 based on the sensed time information, for example, based on an algorithm correlating time versus volume or level. The sensed time information is optionally compared against one or more of the reference times and the level or volume interpolated between the level or volume values corresponding to the reference times. Optionally, the algorithm can calculate the volume or level based at least in part on sensed ambient temperature (e.g., from a sensor S4), to account for variations in how long it takes the temperature to increases by the reference number of degrees depending on ambient temperature (e.g., at high altitude, low altitude, in winter, in summer, etc.).

Use of the one or more temperature sensor S3 therefore advantageously allows measurement of temperature and foodstuff level in the container with one sensor instead of requiring a separate sensor to measure level, which provides for a simpler and less costly system. The temperature control system 200 can optionally have a plurality of temperature sensors S3 along the length of the plateware device 100 and the level of the plateware device 100 can be determined by the electronic module EM by comparing the sensed temperature readings from the plurality of temperature sensors S3 (e.g., estimating that the level is at a location between two adjacent temperature sensors where the temperature readings from said adjacent temperature sensors vary by more than a certain amount).

Though the features disclosed above may be described in connection with the plateware device 100, such as a plate, one of skill in the art will recognize that any of the features described herein can also apply to any drinkware, dishware, serverware, and storage container (e.g., cup, travel mug, baby bottle, sippy cup, thermos, water bottle, such as a reusable water bottle, carafe, soup container, bowl, plate, platter, food storage containers, such as Tupperware® containers, lunch boxes).

While certain embodiments of the inventions have been described, these embodiments have been presented by way of example only, and are not intended to limit the scope of the disclosure. Indeed, the novel methods and systems described herein may be embodied in a variety of other forms. For example, though the features disclosed herein are described for drinkware containers, the features are applicable to containers that are not drinkware containers (e.g., plates, bowls, serverware, food storage containers) and the invention is understood to extend to such other containers. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Though the features and ideas disclosed above may be related to actively heating or cooling food or beverage, the embodiments above may also be used to heat or cool air spaces, such as refrigeration devices, cold boxes, coolers, portable coolers, or portable refrigerators, or hot boxes, or warmer drawers, or heat chambers, or any other device that would benefit from the heating or cooling of the air within a defined cavity or chamber.

The term “electronic module” is meant to refer to electronics generally. Furthermore, the term “electronic module” should not be interpreted to require that the electronics be all in one physical location or connected to one single printed circuit board (PCB). One of skill in the art will recognize that the electronic module or electronics disclosed herein can be in one or more (e.g., plurality) of separate parts (coupled to one or a plurality of PCBs) and/or located in different physical locations of the body of the container, as disclosed herein. That is, the electronic module or electronics can have different form factors.

Of course, the foregoing description is that of certain features, aspects and advantages of the present invention, to which various changes and modifications can be made without departing from the spirit and scope of the present invention. Moreover, the heated or cooled drinkware need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed containers.

1. A plateware device with an active temperature control system, comprising:
a plateware body comprising
a top panel having a central portion and a peripheral portion extending from the central portion to an outer edge, at least a portion of the top panel being made of metal
a bottom panel having a central portion and a peripheral portion extending from the central portion to an outer edge, the central portion defining an opening, the outer edge of the top metal panel attached to the outer edge of the bottom panel to define a double-walled single piece body,
the bottom panel spaced from the top metal panel to define a cavity therebetween, the cavity comprising a peripheral cavity portion defined between the peripheral portions of the top metal panel and bottom panel, and a central cavity portion defined below the central portion of the top metal panel; and
a temperature control system disposed in the cavity between the top metal panel and bottom panel, comprising
one or more heat transfer elements in thermal communication with a bottom surface of the top metal panel to heat at least a portion of the top metal panel, and
control circuitry configured to control operation of the one or more heat transfer elements,
wherein the control circuitry is configured to control the operation of the one or more heat transfer elements, the control circuitry further configured to wirelessly communicate with a mobile electronic device, the control circuitry configured to control the operation of the one or more heat transfer elements based at least in part on information it receives from the mobile electronic device.

2. The system of claim 1, wherein one or both of an outer surface of the top metal panel and an outer surface of the bottom panel comprises a ceramic coating.

3. The system of claim 1, further comprising one or more power storage elements configured to provide power to one or both of the control circuitry and the one or more heat transfer elements.

4. The system of claim 1, further comprising an end cap configured to seal the opening in the bottom panel to inhibit entry of liquid into the cavity, thereby providing a water resistant seal.

5. The system of claim 4, further comprising one or more electrical contacts on a bottom surface of the end cap that electrically connect with the control circuitry and are configured to contact corresponding electrical contacts on a charging or power base on which the plateware device is placed to provide power to one or more components of the temperature control system.

6. The system of claim 1, further comprising insulation disposed at least between the peripheral portions of the top metal panel and the bottom panel to allow the plateware body to sound like a conventional ceramic plateware body.

7. The system of claim 1, wherein the plateware body is a dinner plate.

8. The system of claim 1, further comprising at least one sensor configured to sense a parameter of a foodstuff on the plateware body, the at least one sensor comprising at least one temperature sensor configured to contact a surface of the top metal panel, the at least one sensor configured to communicate with the control circuitry, the control circuitry configured to operate the one or more heat transfer elements based at least in part on the sensed information from the at least one sensor.

9. The system of claim 1, wherein the one or more heat transfer elements are adhered to a bottom surface of the top metal panel.

10. The system of claim 1, wherein the one or more heat transfer elements are one or more heating elements.

11. The system of claim 1, wherein the one or more heat transfer elements comprises a heater flex.

12. The system of claim 1, wherein the outer edge of the top metal panel is attached to the outer edge of the bottom panel by a weld.

13. The system of claim 4, wherein the end cap is made of plastic.

14. The system of claim 1, wherein an entirety of the top panel is made of metal

15. The system of claim 14, wherein the bottom panel is made of metal.

16. The system of claim 15, wherein the top and bottom panels are made of stamped stainless steel.
